(19) United States
(12) Patent Application Publication
(10) Pub. No.: US 2011/0207866 A1
(43) Pub. Date: Aug. 25, 2011

(54) Halogen-Free Dielectric Composition For use As Dielectric Layer In Circuitized Substrates

(76) Inventors: Robert M. Japp, Vestal, NY (US); Kostas I. Papathomas, Endicott, NY (US)

(21) Appl. No.: 12/712,238

(22) Filed: Feb. 25, 2010

(51) Int. Cl. C08K 5/07

(52) U.S. Cl. 524/361

(57) ABSTRACT

A dielectric composition for forming a dielectric layer usable in circuitized substrates such as PCBs, chip carriers and the like. The composition includes at least three resins: a halogen-free flame retardant, methyl ethyl ketone (prior to final layer formation), manganese octoate, and a coupling agent. The composition does not include a halogen or a fluoropolymer as part thereof. Dielectric layers formed from the composition are capable of withstanding the relatively high temperatures associated with lead-free solder applications. The composition may or may not include inorganic filler as part thereof.

### CROSS-REFERENCE TO CO-PENDING APPLICATIONS

In co-pending U.S. patent application Ser. No. 11/265,287, entitled “Dielectric Composition For Use In Circuitized Substrates And Circuitized Substrate Including Same,” filed Nov. 3, 2005 (inventors: R. Japp et al), there is defined a dielectric composition which is adapted for combining with a supporting material (e.g., fiber-glass cloth) to form a dielectric layer usable in circuitized substrates such as PCBs, chip carriers and the like. The layer includes a resin, a predetermined percentage by weight of filler and a minor amount of bromine. A circuitized substrate comprising one or more of these dielectric layers and one or more conductive layers is also defined in the application. The aforementioned application is a continuation-in-part application of U.S. Pat. No. 7,078,816, assigned to the same Assignee as the present invention and is hereby incorporated by reference.

In co-pending U.S. patent application Ser. No. 11/541,776, entitled, “Halogen-Free Circuitized Substrate With Reduced Thermal Expansion, Method of Making Same, Multilayered Substrate Structure Utilizing Same and Information Handling System Utilizing Same,” filed Oct. 3, 2006 (inventors: R. Japp et al), there is defined a circuitized substrate including a composite layer comprising a first dielectric sub-layer comprising a halogen-free resin and fibers dispersed therein and a second dielectric sub-layer without fibers but also including a halogen-free resin with inorganic particulates therein. A method of making such a substrate is also disclosed, as is a multilayered assembly including one or more such circuitized substrates, possibly in combination with other substrates. An information handling system designed for having one or more such circuitized substrates is also described. The aforementioned patent application is also assigned to the same Assignee as the present invention and is hereby incorporated by reference.

### FIELD OF THE INVENTION

The invention described herein relates to dielectric compositions for use in producing dielectric layers for circuitized substrates such as those utilized in printed circuit boards (hereinafter also referred to as PCBs), chip carriers and the like, particularly as electrically insulating layers between electrically conductive layers such as signal, power and ground layers which form part of the final structure. Most particularly, the invention relates to such compositions that assure that resulting products are able to include highly dense circuitry in such conductive layers, if desired, as well as products capable of processing high-speed signals.

### BACKGROUND OF THE INVENTION

PCBs, chip carriers and related products used in many of today's technologies must include multiple circuits in a minimum volume or space. Typically, such products comprise a “stack” of layers of signal, ground and/or power planes separated from each other by at least one layer of electrically insulating dielectric material. The circuit lines or pads (e.g., those of the signal planes) are often in electrical contact with each other by plated holes passing through the dielectric layers. The plated holes are often referred to as “vias” if internally located, “blind vias” if extending a predetermined depth within the board from an external surface, or “plated-thru-holes” (hereinafter also referred to simply as PTHs) if extending substantially through the board's full thickness. The term “thru-hole” as used herein is meant to include all three types of such board openings.

Complexity of these products has increased significantly in recent years. PCBs for mainframe computers may have as many as thirty-six layers of circuitry or more, with the complete stack having a thickness of as much as about 0.250 inch (250 mils). These boards are typically designed with three or five mil wide signal lines and twelve mil diameter thru-holes. Increased circuit densification requirements seek to reduce signal lines to a width of two mils or less and thru-hole diameters to two mils or less. Many known commercial procedures, especially those of the nature described herein, are incapable of economically forming these dimensions now desired by the industry. Such processes typically comprise fabrication of separate innerlayer circuits (circuitized layers), which are formed by coating a photosensitive layer or film over a copper layer of a copper clad innerlayer base material. The photosensitive coating is imaged and developed and the exposed copper is etched to form conductor lines. After etching, the photosensitive film is stripped from the copper, leaving the circuit pattern on the surface of the innerlayer base material. This processing is also referred to as photolithographic processing in the PCB art and further description is not deemed necessary.

After the formation of the individual innerlayer circuits, a multilayer stack is formed by preparing a lay-up of innerlayers, ground planes, power planes, etc., typically separated from each other by a dielectric pre-preg comprising a layer of glass (typically fiberglass) cloth impregnated with a partially cured material, typically a B-stage epoxy resin. The top and bottom outer layers of the stack usually comprise copper clad, glass-filled epoxy planar substrates with the copper cladding comprising exterior surfaces of the stack. The stack is laminated to form a monolithic structure using heat and pressure to fully cure the B-stage resin. The stack so formed typically has metal (usually copper) cladding on both of its exterior surfaces. Exterior circuit layers are formed in the copper cladding using procedures similar to the procedures used to form the innerlayer circuits. A photosensitive film is applied to the copper cladding. The coating is exposed to patterned activating radiation and developed. An etchant is then used to remove copper bared by the development of the photosensitive film. Finally, the remaining photosensitive film is removed to provide the exterior circuit layers.

The aforementioned thru-holes (also often referred to as interconnects) are used in many such substrates to electrically connect individual circuit layers within the structure to each other and to the outer surfaces. The thru-holes typically pass through all or a portion of the stack. Thru-holes are generally formed prior to the formation of circuits on the exterior surfaces by drilling holes through the stack at appropriate locations. Following several pre-treatment steps, the walls of the holes are catalyzed by contact with a plating catalyst and metallized, typically by contact with an electroless or electrolytic copper plating solution to form conductive pathways between circuit layers. Following formation of the conductive thru-holes, exterior circuits, or outer layers are formed using the procedure described above.

After construction, chips and/or other electrical components are mounted at appropriate locations on the exterior circuit layers of the multilayered stack, typically using solder mount pads to bond the components to the PCB. The components are often in electrical contact with the circuits within the structure through the conductive thru-holes, as desired. The solder pads are typically formed by coating an organic solder mask coating over the exterior circuit layers. The solder mask may be applied by screen coating a liquid solder mask coating material over the surface of the exterior circuit layers using a screen having openings defining areas where solder mount pads are to be formed. Alternatively, a photoimageable solder mask may be coated onto the board and exposed and developed to yield an array of openings defining the pads. The openings are then coated with solder using processes known to the art such as wave soldering.

With respect to such soldering, lead-free solders are presently being utilized in many circuitized substrate assemblies, and are finding more and more acceptance due to current environmental concerns about using lead, a required element in many known solder compositions. Examples of such lead-free solder compositions include Sn-based alloys including SnAg alloys, SnSb alloys and SnZn alloys. As is also known, the soldering temperature for such solders, examples being as high as 260 degrees C. to 280 degrees C., is considered relatively high for use with dielectric substrates. When soldering is performed at such elevated temperatures, electronic components such as resistors, capacitors, modules and even the base printed circuit board may be thermally damaged, resulting in functions thereof being partially or completely terminated.

One example of a relatively recent lead-free solder composition is discussed in U.S. Pat. No. 7,601,228. The solder composition described therein contains a lead-free SnZn alloy and a solder flux that contains at least an epoxy resin and an organic carboxylic acid. The organic carboxylic acid is dispersed in the solder composition as a solid at room temperature, and has a molecular weight of from 100 to 200 g/mol. This patent claims to reduce the soldering temperatures associated with such lead-free solders.

The necessity of developing ever-increasing high speed circuitized substrates for use in many of today's new products (e.g., computers) has led to the exploration of new materials to extend the electrical and thermal performance limits of the presently available technology. For high-speed applications, it is necessary to have extremely dense conductor circuitry patterning on low dielectric constant insulating material. Prepreg laminates for conventional circuit boards traditionally consist of a base reinforcing glass fabric impregnated with a resin, also referred to by some in the industry as “FR4” dielectric material. Epoxy/glass laminates used in some current products typically contain about 40% by weight fiber glass and 60% by weight epoxy resin, and typically have a relatively high dielectric constant (Er), sometimes higher than 4.0. Such a relatively high Er in turn causes electrical pulses (signals) in adjacent signal circuit lines to propagate less rapidly, resulting in excessive signal delay time. As newer computer systems become faster, system cycle times must become shorter. Delay time contributed by signal travel within the PCBs and other circuitized substrates used in such products become significant; hence the need for lower Er laminate materials exists.

Many products are expected to require overall an Er of 2.8 or below. Such a low Er is impossible to obtain without new materials since the Er of conventional FR4 epoxy and common fiberglass, as indicated above, is typically in the 4-6 range. The effective Er of such composite materials can usually be approximated by a simple weighted average of the Er of each individual component and its volume fraction contained in the composite.

Also important is dissipation factor or loss factor. A lower dissipation factor results in lower circuit noise and also enables faster signal transmission speeds. As further explained below, the above compositions are also often heavily weighted with brominated components (bromine being a halogen element) to assure the desired FR rating.

Another known dielectric material is polytetrafluoroethylene (PTFE). However, using such a material alone in construction of a circuit board laminate has sometimes proven impractical, due to generally poor mechanical properties and chemical inertness of this material. One alternative is to use fluoropolymer as one of the components of a composite laminate material, such as the fiber in the reinforcing cloth. An example of this is the treated PTFE fabric prepreg produced by W. L. Gore and Associates of Newark, Del. When this type of fabric is used to replace fiberglass in conventional epoxy/glass laminates, the Er drops to 2.8. However use of this fabric also presents certain disadvantages. Because of the comparatively low modulus of pure PTFE, thin laminates made with these materials are not very rigid, and require special handling care. Also when laminates incorporating PTFE fabric are drilled, uncut PTFE fibers tend to protrude into the drilled holes and are difficult to remove. In order to obtain good plating adhesion, exposed PTFE surfaces must be treated using either an expensive, highly flammable chemical in a nitrogen atmosphere or by plasma processing, which must penetrate high aspect ratio thru-holes in order to obtain good plating adhesion. Certainly, one of the biggest disadvantages of PTFE fabric laminate is cost: not only the higher cost due to additional processing requirements and equipment modification, but also the considerable cost of purchasing the prepreg material itself. Ideally, the value of the Er should approach 1.0, the value in a vacuum.

In U.S. Pat. No. 5,652,055, there is described an adhesive sheet (or “bond film”) material suitable to serve as adhesive layers in a variety of applications, such as in circuit board laminates, multi-chip modules, and other electrical applications. The adhesive sheet is constructed from an expanded PTFE material, such as that taught in U.S. Pat. No. 3,953,566.

Preferably, the material is filled with an inorganic filler material and is constructed as follows. Ceramic filler is incorporated into an aqueous dispersion of dispersion-produced PTFE. The filler in small particle form is ordinarily less than 40 microns in size, and preferably less than 15 microns. Other types of expanded-PTFE substrate materials are described in U.S. Pat. Nos. 4,187,390 and 4,482,516. U.S. Pat. No. 4,187,390 is particularly interesting because it delves substantially into both nodes and fibrils used as part of such substrate materials, breaking these down into such dimensional constraints as node height, node width, node length, and fibril length.

There are environmental concerns, however, with respect to the use of fluoropolymers. PTFE, for example, is produced by the polymerization of tetrafluoroethylene (TFE). During this polymerization, TFE becomes dissolved in chlorofluorocarbons (CFCs), which are known to be detrimental to the earth's ozone layer, causing depletion of said layer. The lack of reactivity of CFCs gives them a lifespan that can exceed 100 years, giving them time to diffuse into the upper stratosphere. Once in the stratosphere, the sun's ultraviolet radiation is strong enough to cause the homolytic cleavage of the C—Cl bond, resulting in release of chlorine atoms which then deplete the ozone layer.

Another property affecting the performance of a laminated dielectric material is the coefficient of thermal expansion (CTE). It is desirable to closely match the coefficients of thermal expansion in the X and the Y directions of the dielectric material to that of the adjacent layer in order to prevent cracking of soldered joints linking the PCB to surface mounted devices, or to avoid separation of copper from the dielectric, or to prevent PCB warping. The X and Y direction CTEs are normally controlled by the glass fibers within the matrix. However these fibers do not affect Z direction CTE, which must also be controlled in order to prevent cracking of copper plated thru-holes during heat cycling. Heat is generated in preparing or reworking solder connections, and in other manufacturing processes, and by current flow when the finished board is in operation. Solder connections are also subjected to temperature variations during shipment or storage.

One way to modify the CTE is by the use of fillers. Fillers may be linked to the matrix polymer to which fillers are added by the use of a coupling agent, often a silane.

The coupling agent improves the bonding between the filler and the polymer, optimizing the interfacial bond area, which improves both electrical and mechanical performance. Fillers of various types can affect the dielectric loss of a composite.

The CTE of a prepreg dielectric material changes markedly when an inflection point called the glass transition temperature (Tg) is reached. Since the expansion rate of the dielectric material increases considerably when the Tg is reached, it is desirable for a dielectric material to have a high Tg in order to minimize stresses. Other characteristics associated with high Tg often include low moisture absorption and chemical resistance.

Another known material that attempts to meet flame retardant requirements is described in U.S. Pat. No. 5,126,192. In this patent, a resin/silane treated microsphere/carrier structure prepreg is prepared, B-stage cured, and then vacuum laminated. The impregnation mix is prepared by adding a predetermined quantity of microspheres to the resin/solvent mixture sufficient to result in a packing factor of, e.g., about 50% when the solvent is driven off. A low shear mixing technique must be used to avoid damaging the microspheres. Because these are spherical, the microspheres mix in readily and do not increase the viscosity of the solution to a point beyond which impregnation is difficult. The combination of microsphere size and packing factor allegedly enables the filled dielectric material to withstand the heat and pressure cycle of lamination without undergoing breakage of the hollow microspheres.

The carrier/reinforcement material in this patent may be any known type of reinforcement such as glass or PTFE. The carrier fabric selected depends mostly on the properties desired for the finished laminate. Carrier materials include woven and non-woven fiberglass and polymer fabrics and mats. Organic films such as polyimide film can also be used. Low Er fabrics such as D-glass, aramids such as KEVLAR™ and NOMEX™, both registered trademarks of E. I. Dupont de Nemours and Company, poly p-phenylene benzobisthiazole, poly p-phenylene benzobisoxazole, polyetheretherketone, aromatic polyesters, quartz, S-glass, and the like can also be used in the formulation. The reinforcement can be in a co-woven or comingled form.

In U.S. Pat. No. 5,418,689, there is described a PCB dielectric substrate composition including a thermoplastic and/or thermosetting resin. Thermosetting polymeric materials mentioned in this patent include epoxy, phenolic base materials, polyimides and polyamides. Examples of some phenolic type materials include copolymers of phenol, resorcinol, and cresol. Examples of some suitable thermoplastic polymeric materials include polyolefins such as polypropylene, polysulfones, polycarbonates, nitrile rubbers, ABS polymers, and fluorocarbon polymers such as PTFE, polymers of chlorotrifluoroethylene, fluorinated ethylenepropylene polymers, polyvinylidene fluoride and polyhexafluoropropylene.

The dielectric materials may be molded articles of the polymers containing fillers and/or reinforcing agents such as glass filled polymers. FR4 epoxy compositions that are employed in this patent contain 70-90 parts of brominated polyglycidyl ether of bisphenol-A and 10-30 parts of tetrakis (hydroxyphenyl)ethane tetraglycidyl ether cured with 3-4 parts of dicyandiamide, and 0.2-0.4 parts of a tertiary amine, all parts being parts by weight per hundred parts of resin solids.

Another FR4 epoxy composition may contain about 25 to about 30 parts by weight of a tetrabrominated digylcidyl ether of bisphenol-A having an epoxy equivalent weight of about 350 to about 450; about 10% to about 15% by weight of a tetrabrominated glycidyl ether of bisphenol-A having an epoxy equivalent weight of approximately 600 to about 750 and about 55 to about 65 parts per weight of at least one epoxidized nonlinear novolak having at least 6 terminal epoxy groups; along with suitable curing and/or hardening agents.

A still further FR4 epoxy composition contains 70 to 90 parts of brominated polyglycidyl ether of bisphenol-A and 10 to 30 parts of tetrakis (hydroxyphenyl)ethane tetraglycidyl ether cured with 0.8-1 phr of 2-methylimidazole. Still other FR4 epoxy compositions employ tetrabromobisphenol-A as the curing agent along with 2-methylimidazole as the catalyst.

Another known material designed for use in circuitized substrates such as defined above and which is intended to also meet the above requirements of today's high-speed products is described in U.S. Pat. No. 6,207,595. In this patent, the dielectric layer's fabric material is made from a cloth member having a low enough content of particulates and a sufficient quantity of resin material to completely encase the cloth member including the particulates. The resin material extends beyond the highest protrusions of the cloth member. The fabric material is thicker and will pass a certain test standard (in '595, the known HAST level A test). Thus, the woven cloth is known to include a quantity of particulates, which term is meant in the '595 patent to include dried film, excess coupler, broken filaments, and gross surface debris. The resin may be an epoxy resin such as one often used for FR4 composites. A resin material based on bismaleimide-triazine (BT) is also acceptable for the structure in this patent.

In U.S. Pat. No. 6,323,436, PCBs are prepared by first impregnating a non-woven aramid chopped fiber mat or a thermoplastic liquid crystalline polymer (LCP) paper instead of the reinforcement typically used in the electronics industry, described in this patent as a woven glass fabric. The aramid reinforcement comprises a random (in-plane) oriented mat of p-aramid (polyp-phenylene terephthalamide) fibers comprising KEVLAR™, and has a dielectric constant of 4.0 as compared to 6.1 for standard E-glass cloth. The lower permittivity of the non-woven aramid reinforcement provides for faster signal propagation, allowing increased wiring density and less crosstalk, which becomes increasingly important for high I/O chips and miniaturization. Examples of thermosetting resins include epoxy, cyanate ester, bismaleimide, bismaleimide-triazine, maleimide or combinations thereof. The resin-impregnated low CTE reinforcement is then partially cured to a “B-stage” to form the prepreg, and then the prepreg is cut, stacked, and laminated to form a subcomposite with exterior copper sheets.

In U.S. Pat. No. 7,078,816, there is defined a circuitized substrate, electrical assembly and information handling system capable of utilizing dielectric layers made using the bromine-containing dielectric composition taught in co-pending patent application Ser. No. 11/265,287, cited above. A method of making the substrate is also defined in the '816 patent, which is also assigned to the same Assignee as the present invention.

In U.S. Pat. No. 7,145,221, there is defined a circuitized substrate comprising a first layer comprising a dielectric material including a low moisture absorptive polymer resin in combination with a nodular fluoropolymer web encased within the resin, the resulting dielectric layer formed from this combination not including continuous or semi-continuous fibers as part thereof. The substrate further includes at least one circuitized layer positioned on the dielectric first layer. The '221 patent is also assigned to the same Assignee as the present invention.

In U.S. Pat. No. 7,270,845, there is defined a dielectric composition which forms a dielectric layer usable in circuitized substrates such as PCBs, chip carriers and the like. The dielectric layer includes a cured resin material and a predetermined percentage by weight of particulate fillers, not including continuous fibers, semi-continuous fibers or the like as part thereof. The '845 patent is also assigned to the same Assignee as the present invention.

In U.S. Pat. No. 7,470,990, there is defined a circuitized substrate including a composite layer including a first dielectric sub-layer having a plurality of fibers with a low coefficient of thermal expansion and a second dielectric sub-layer of a low moisture absorptivity resin, the second dielectric sub-layer not including continuous or semi-continuous fibers as part thereof. The substrate further includes at least one electrically conductive layer. The '990 patent is also assigned to the same Assignee as the present invention.

Finally, in U.S. Pat. No. 7,646,098, there is defined a multilayered circuitized substrate comprising a core substrate including a first dielectric layer having a p-aramid paper impregnated with a composition including halogen-free, low moisture absorptivity resin that includes an inorganic particulate filler and does not include continuous or semi-continuous fiberglass fibers as part thereof. A first circuitized layer is directly positioned on this first thin dielectric layer and a second dielectric layer is bonded to the thin core. The '098 patent is also assigned to the same Assignee as the present invention and is a continuation-in-part application of U.S. Pat. No. 7,470,990.

In some known dielectric compositions, as mentioned above (e.g., the FR4 dielectric material), halogens (one known example being bromine) are used as one of the composition elements. Bromine, for example, may be considered beneficial to provide moisture and flammability resistance and to assist in assuring a high Tg. for the resulting structure. In one known composition, this material is believed to constitute approximately 30% of the composition, by weight, in addition to bisphenol-A, a known industrial chemical used in epoxy resins and other products, and epoxy cresol novolac resin. However, Applicants are of the opinion that bromine in such relatively high percentages is increasingly considered to be undesirable when used with some resins, to the extent that it adversely affects the electrical properties of the base resin. Further, because many of today's and future substrates are expected to have components bonded thereto using lead-free solders, which typically require higher temperatures, the requirement of bromine, particularly as a fire retardant in almost any amount, is considered undesirable. The dielectric containing same may be unable to satisfactorily withstand such high temperatures. Finally, certain bromine-related compounds have been evaluated to have ozone depletion potential. As a result, many industrial bromine compounds are no longer manufactured, are being restricted or scheduled for phasing out.

The present invention represents a significant improvement over dielectric compositions such as those above. The composition of the invention does not include halogens (especially bromine) or fluoropolymers as part thereof, and, very significantly, is capable of producing dielectric layers able to substantially withstand the relatively high temperatures associated with lead-free solder application. Still further, the dielectric layers formed using these compositions are able to: support high speed signal transmissions through the substrate's electrically conductive signal planes; assure a relatively low dielectric constant; and assure low moisture absorption. Additional advantageous features of this composition are defined in greater detail hereinbelow.

It is believed that such an invention will represent a significant advancement in the art.

### OBJECTS AND SUMMARY OF THE INVENTION

It is a primary object of the invention to enhance the art of circuitized substrates.

It is another object to provide an improved dielectric composition which can be utilized to form a dielectric layer within a circuitized substrate and which can be produced successfully using conventional manufacturing procedures.

It is still another object of this invention to provide such a composition that will possess many desirable attributes necessary for successful incorporation with substrates to assure high-speed signal passage and adaptability to lead-free solder applications.

According to one embodiment of the invention, there is provided a dielectric composition adapted for use as a dielectric layer in circuitized substrates, this composition comprising predetermined percentages of bismaleimide triazine resin, polyepoxide resin, thermoplastic resin, halogen-free flame retardant, methyl ethyl ketone, manganese octoate, and a coupling agent, this composition not including a halogen or a fluoropolymer as part thereof.

According to another embodiment of the invention, there is provided a dielectric composition adapted for use as a dielectric layer in circuitized substrates, this composition comprising the above elements and a quantity of inorganic particulate filler.

According to yet another embodiment of the invention, there is provided a dielectric layer formed from the above composition, excluding the methyl ethyl ketone as part thereof due to it being driven off during the layer formation.

### BEST MODE FOR CARRYING OUT THE INVENTION

For a better understanding of the present invention, together with other and further objects, advantages and capabilities thereof, reference is made to the following disclosure and appended claims.

By the term “circuitized substrate” as used herein is meant a substrate product including one or more dielectric layers and one or more electrically conductive layers. Such products as known in the art include printed circuit boards (a/k/a printed wiring boards) and cards, and chip carriers (substrates adapted for having one or more electronic components such as a semiconductor chip mounted thereon). Typically, the conductive layers comprise copper or copper alloy, while previously known dielectric materials include the aforementioned, perhaps the most widely known being the described FR-4 fiber-glass reinforced resin material. Examples of both such products are described in detail in the foregoing patents and other known documentation and further description is not believed necessary. It is understood from the teachings herein that such substrates having dielectric layers formed from the new and unique compositions taught herein represent significant improvements to the substrate art and thus the art of products utilizing same.

The circuitized substrates produced with dielectric layers formed of the dielectric compositions taught herein are adapted for use in many electronic products, perhaps the best known of these being what may be referred to as “information handling systems.” As used herein, this term shall mean any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as computer servers and mainframes. Such products are well known in the art and are also known to include PCBs and other forms of circuitized substrates as part thereof, some including several such components depending on the operational requirements thereof.

As defined herein, the compositions of this invention, when used with cloth supporting material (e.g., fiber-glass) or simply in combination with a conductive layer (e.g., copper or copper alloy), provide a dielectric layer within a circuitized substrate that exhibits reduced dielectric constant, reduced dielectric loss factor, reduced cure shrinkage and reduced CTE. In addition, the resulting dielectric layers made of these compositions will not include any fluoropolymers or any halogens (including bromine) as part thereof, both of said elements not desired for the reasons stated above.

In one embodiment, the dielectric composition of the invention comprises bismaleimide triazine resin (providing good electrical performance properties, excellent insulation resistance, and good adhesion), polyepoxide resin (providing excellent temperature and moisture resistance as well as low electrical loss factor), thermoplastic resin (providing flexibility and flaking resistance), halogen-free flame retardant, methyl ethyl ketone, manganese octoate (acting as a catalyst) and a coupling agent. All of these percentages are by weight of the composition. In this particular embodiment, no inorganic fillers are utilized and thus some percentages are somewhat greater than for the filler embodiment defined hereinbelow.

In this inorganic filler-less embodiment, the percentage of bismaleimide triazine resin is within the range of from about 35% to about 42%, the percentage of polyepoxide resin within the range of from about 3% to about 10%, the percentage of thermoplastic resin within the range of from about 9% to about 15%, and the percentage of halogen-free flame retardant within the range of from about 10% to about 33%. Significantly, in this embodiment, the retardant also serves as a filler. The percentage of methyl ethyl ketone (MEK) is within the range of from about 20% to about 40%. Significantly, the MEK is in transient liquid form and present only in a varnish state at this point; however, it is absent when the composition is in the dielectric layer form. The percentage of manganese octoate is within the range of from about 0.025% to about 0.075% and the percentage of a coupling agent is within the range of from about 0% to about 1%.

In a more specific example of this first embodiment wherein no inorganic filler is used, the percentage of bismaleimide triazine resin is about 38%, the percentage of polyepoxide resin about 7%, the percentage of thermoplastic resin 14%, the percentage of halogen-free flame retardant about 19%, the percentage of methyl ethyl ketone about 21%, the percentage of manganese octoate about 0.050% and the percentage of a coupling agent about 0.5% of the total varnish mixture. As understood from the above, the percentage of MEK may be tailored to achieve varnish viscosities that are readily adaptable to corresponding coating methods and the desired final thicknesses of the formed films (layers).

A preferred bismaleimide triazine resin is available from Mitsubishi Gas Chemical Co. Inc., Japan, and marketed under the product name “MGC 2060B.” A preferred polyepoxide resin is a commercially available dicyclopentadiene-containing polyepoxide resin marketed under the product name “TACTIX 756” by Huntsman Chemical, East Lansing, Mich. A preferred thermoplastic resin is sold under the trade name “PKHS-40” resin, by Inchem Corporation in Rock Hill, S.C. Essentially, this resin serves as a flexibilizer for the composition. A preferred halogen-free fire retardant is marketed under the name “Exolit OP 930” by Clariant Corporation, Charlotte, N.C. “Exolit OP 930” is a white, fine-grained powder based on an organic phosphinate, is not hygroscopic, and is insoluble in water and common organic solvents such as the methyl ethyl ketone also used in this composition. In this regard, methyl ethyl ketone is widely available from many sources, including Green Chem Industries, having a business location in West Palm Beach, Fla. One source for the manganese octoate or octanoate used in this invention is Omg America's Inc, having a business location in Franklin, Pa. The preferred coupling agent is silane, and more preferably one sold under the trade name “Z-6040”, available from Rohm and Haas Electronic Materials, Freeport, N.Y. Other suitable silanes include y amino propyl triethoxy silane and β-(3,4-epoxy cyclohexyl)ethyltrimethoxy silane. It is understood that the invention is not limited to only these specific products and corresponding sources, as alternatives are possible.

According to an alternative embodiment, the composition of the invention including the above elements (but in different percentages, as identified below) further includes a quantity of inorganic particulate filler. In one example, this filler is silica and comprises from about 15% to about 49% by weight of the composition. Additional filler materials include alumina, aluminum oxide, aluminum nitride, silicon nitride, silicon carbide, beryllium oxide, boron nitride, diamond powder, titanium oxide, ceramic and combinations thereof. One preferred example of such silica is sold by Tatsumori, Ltd., having a business location at #2-9-3 Shibakoen Minato-ku, Tokyo, Japan (represented by Tatsumori U.S.A., Inc., New York, N.Y.), under the product name “PLV-6”. Another silica is Tatsumori's “PLV-4”. Combinations of these are also possible. This silica is spherical amorphous silica, and, in the percentages described above, provides a determining factor in the CTE for the resulting dielectric layer. The spherical nature of this filler allows high volumetric loading of the filler without driving the melt viscosity of the composition too high to preclude ordinary lamination processing.

In one specific example, about 43% by weight of this silica may be used. The silica may be in the form of spherical or semi-spherical amorphous particles or in the form of hollow silica microspheres, or combinations thereof. The silica filler material is an important element in this embodiment of the composition because it allows for the reduction in glass cloth support material, if the composition is used in combination therewith, while still achieving low (and more isotropic in nature) CTE values for the composition. The inclusion of such a filler can result in an isotropic CTE providing additional reliability to the plated thru-holes which is another attribute of the present composition and invention.

The inclusion of silica also improves electrical properties because its displacement of some of the glass cloth provides the composition with a lower dielectric constant (Er), the cloth having a higher Er value. Since silica also has low moisture absorption properties, its inclusion partially compensates for any possible reduced resin hydrophobicity. Adding particulate filler such as this silica would normally increase the brittleness of the resulting dielectric layer, which is of course undesirable. This is overcome by the use of the aforementioned thermoplastic resin material (e.g., “PKHS-40” thermosetting resin), which assures that such brittleness in the final layer is at a reduced, acceptable level. In one example, the silica particles each have a size within the range of about 200 Angstroms to about 35 microns, a preferred size being about 10 microns. The above ranges are not meant to limit the invention, as others are acceptable.

As mentioned, when inorganic particulate filler is utilized, selected levels of the percentages of the accompanying other elements in the composition are altered. In a composition wherein the defined percentage of weight of about 15% to about 20% filler is used, the percentage of bismaleimide triazine resin is reduced, to within the range of from about 29% to about 36%, the percentage of polyepoxide resin is allowed to remain substantially within the range of from about 3% to about 10%, the percentage of thermoplastic resin is reduced to within the range of from about 6% to about 12%, the percentage of halogen-free flame retardant remains substantially the same, within the range of from about 10% to about 27%, the percentage of methyl ethyl ketone is increased slightly to within the range of from about 20% to about 50%, the percentage of manganese octoate remains substantially the same within the range of from about 0.025% to about 0.075%, and the percentage of a coupling agent remains substantially the same within the range of from about 0% to about 1%.

In a more specific example of this filler composition embodiment, the percentage of bismaleimide triazine resin is about 32%, the percentage of polyepoxide resin about 7%, the percentage of thermoplastic resin about 9%, the percentage of halogen-free flame retardant about 19%, the percentage of methyl ethyl ketone about 35%, the percentage of manganese octoate about 0.050% and the percentage of a coupling agent about 0.5%.

The compositions of the present invention are particularly adapted for use with what is referred to in the art as “p-aramid paper.” The term “p-aramid” as used herein is meant a para-aromatic polyamide of which the polymeric main chain is composed wholly or for the most part of aromatic nuclei, such as phenylene, biphenylene, biphenyl ether, naphthylene, and the like, which are interconnected wholly or for the most part via the para-position (1,4-phenylene) or a comparable position (e.g., 2,6-naphthylene). Preferably, the aromatic nuclei are phenylene groups; more preferably, the polymer is PPTA, which can be prepared in a known manner by the reaction in an appropriate solvent (notably CaCl₂-containing N-methyl pyrrolidone) of stoichiometric amounts of para-phenylene diamine (PPD) and terephthalic acid dichloride (TDC). Use of aramid fiber materials is known for such molded items as speaker cones and parts having good acoustical properties. Aramid fiber material for speaker cones generally combines crystallized p-aramid fibers and amorphous m-aramid fibrids, the fibrids acting as a binder for the p-aramid fibers by softening and bonding the fibers when the formed sheets are subjected to high pressure and temperature. Such aramid fiber papers typically have coloring similar to that of the base fiber. The p-aramid fiber-containing KEVLAR™ is also known for its good fire retardant properties, as are other p-aramid materials. Use of p-aramid fibers is also known in products such as asbestos replacement items (e.g., braking pads), hot air filtration fabrics, tires, ropes and cables, optical fiber cable systems, sail cloth, sporting goods, drumheads, wind instrument reeds, boat hull material, reinforced thermoplastic pipes, and tennis strings.

In this invention, the p-aramid paper is impregnated with the three resins, the flame retardant, the coupling agent and the manganese octoate to have a thickness according to one embodiment of from only about 20 microns to about 200 microns. Significantly, when the composition is being used to impregnate the paper, the bismaleimide triazine resin includes about 65% solids in methyl ethyl ketone, the polyepoxide resin is at about 100% solids, and the thermoplastic resin includes about 40% solids in methyl ethyl ketone. The manganese octoate is at about 6% solids in mineral spirits. The composition includes the 20% to about 40% methyl ethyl ketone.

This composition forms what is referred to as a liquid varnish, which is then coated onto the p-aramid paper. In this embodiment, the resin matrix of the formed layer comprises from about 10% to about 80% by weight of the layer. The coated paper layered structure is then dried, driving off the methyl ethyl ketone solvent, B-staged, and then adapted for being laminated using conventional PCB lamination processing with other layers desired for use as part of the desired finished circuitized substrate. Typically, such substrates include more than one such dielectric layer in addition to several conductive layers, usually alternately disposed in the layered form. The result following lamination is a circuitized substrate having the several highly advantageous features defined herein.

As mentioned, this embodiment of the invention does not include or require glass (e.g., fiberglass) fibers for support. Not including such fiberglass fibers, the CTE of each formed dielectric layer may be from about 8 to about 23 parts per million (ppm) per degree C. in both x and y directions. Resulting dielectric layers formed from the compositions are each capable of having a plurality of thru-holes formed therein, in patterns having relatively high densities of as much as 5,000 to about 10,000 holes per square inch of the dielectric area.

As stated, the compositions of the invention are also capable of having the defined inorganic particulate filler as part thereof. When the inorganic filler is used in the amounts stipulated above, the composition is designed for being directly applied to a conductive layer, preferably a foil of copper or copper alloy, to form what is also referred to in the art as a resin coated copper (RCC) layered product. The composition may be applied to the copper foil with a process such as reverse roll coating or slot die coating, after which the methyl ethyl ketone solvent is driven off, the material further baked to partially cure it (B-staged), and then cut into sheets which can then be laminated under the heat and pressure of conventional PCB lamination to form the various layers within a laminated chip carrier, for example. Prior to such lamination, these layered products may also of course be subjected to additional substrate processing such as circuitizing, where the copper is formed into a desired circuit pattern, and where individual thru-holes are formed, etc. This may also occur for the layered products formed using the filler-less composition cited above, if such further processing is desired.

Compositions of the invention having inorganic particulate filler may also be used with glass cloth (e.g., fiberglass) support layers, the use of such cloth known in the art. The glass cloth may be impregnated with the composition materials, dried, B-staged and then laminated in the normal manner (known PCB lamination processing) with other layers desired for use as part of the finished circuitized substrate, including the aforementioned conductive layers, as well as other dielectric layers. The inclusion of the silica filler material as taught herein allows for the use of thinner and lighter styles of glass cloths while still achieving the desired thicknesses and also while maintaining or improving the dimensional changes both in the x-y and vertical planes of a circuitized substrate.

The resulting combination of silica filler and thinner, lighter cloths also improves laser drilling of the dielectric layer to provide the aforementioned thru-holes. The insulation resistance reliability of the laminated material is also improved due to the reduction of the glass fiber contact with the conductive material. Of further significance, the presence of the silica filler material improves the adhesion between resin and copper layer, as well as serving to improve crack resistance.

One example of a dielectric layer formed using one of the compositions of the invention is provided below, in addition to the properties attained when using said composition.

### EXAMPLE

| Material | Name | Weight gm) |
|---|---|---|
| Tatsumori PLV-6 | Fused silica | 50.000 |
| Mitsubishi BT 2060-B | Bisphenol A diacyanate | 38.725 |
| | Oligomer | |
| PKHS-40 | Phenoxy resin | 12.000 |
| Tactix-756 | Epoxy resin | 6.970 |
| Exolit-930 | Organophosphorous salt | 13.158 |
| Z-6040 | Alkoxy silane | 0.265 |
| Manganese hexanoate (6% is | | 0.0483 |
| mineral spirits solution) | | |
| MEK | Solvent | 70.000 |
| Total | | 191.160 |

In this example, the BT 2060B resin, Tactix-756 epoxy resin, Exolit 930 salt, Z-6040 silane, 6% manganese hexanoate in mineral spirits, and the PKHS-40 resin (40 percent by weight in MEK) were mixed with the MEK in a glass container for a time period sufficient to obtain a substantially uniform solution. To this solution, PLV-6 fused silica was dispersed, using a high shear mixer. The amount of MEK was adjusted accordingly to produce a mixture capable of coating good quality films using methods well known in the art of coating industry. This composition was later used to produce a prepreg (glass cloth impregnated with the solution) dielectric layer that was subsequently laminated to produce a laminate capable of being used as part of a circuitized substrate.

The above composition was then coated onto a copper foil of low profile, preferably, forming a resin coated copper (RCC) member. The RCC member was partially advanced in an in-line oven at 130 to 140 degrees C. for about 3 minutes residence time. The coated copper had an average uniform thickness of about 17-60 microns and minimum viscosity of about 7000 Pascal-seconds. Laminated structures fabricated from this prepreg layer using 800 p.s.i. lamination pressure and 200 degrees C. lamination temperature were tested; the results are shown in the following table.

TABLE

| | |
|---|---|
| Electrical properties: | |
| Er, 1-2.5 Ghz average | 3.14 |
| Loss factor at 1 Mhz | 0.006 |
| Thermal properties: | |
| Lamination temperature (deg. C.) | 205.00 |
| Tg - DSC mid pt, deg. C. post lamination | 218.00 |
| Tg - DSC mid pt, deg. C. post bake 200 C./1 hr | 217.00 |
| Decomp temp., deg. C. (5% loss) | 358.00 |
| T-260 w/cu., min. | >120 |
| Flammability, rating | V0 |
| Physical properties: | |
| PCT, 60 min. | 8/8 pass |
| Moisture, 24 hr. RT - % | 0.27 |
| Moisture, 1 hr. PCT. - % | 0.70 |
| Cu bond.- 0.5 oz., lb/in | 6.00 |
| Bond film 90 deg. - lb/in | 4.20 |
| Thermal Expansion: | |
| x, y, z below Tg, ppm/C. | 30.00 |
| x, y, z above Tg, ppm/C. | 76.00 |
| Min visc. (Pa - s): | 2000-15000 |
| Temp at minimum viscosity (deg. C.) | 120-132 |
| Mechanical Properties: | |
| Tensile Ductility (%)(X/Y) | 2.5-3% |
| Film format & thickness: | |
| Copper thickness (μm) | 18.00 |
| Coating thickness (μm) | 33.5 and 47 |

A particular use for the individual dielectric layers formed using the compositions of this invention is to become parts of circuitized substrates such as chip carriers or PCBs or other electronic packaging products, including those produced and sold by the Assignee of this invention, Endicott Interconnect Technologies, Inc. One particular application is a chip carrier sold under the name CoreEZ®. (CoreEZ® is a registered trademark of Endicott Interconnect Technologies, Inc.) The invention is of course not limited to chip carriers or even to higher level PCBs. It is also understood that such dielectric layers may be used to form what are referred to in the substrate art as “cores,” a specific example a “power core” if the core includes one or more power planes and is thus to serve primarily in this capacity. Like other conductive-dielectric layered substrates, such cores may in turn be stacked up with other layers, including conductors and dielectrics, and bonded together, preferably using conventional PCB lamination processing, to form a multilayered carrier or multilayered PCB. As also mentioned above, the laminate so formed is then subjected to further processing, including conventional photolithographic processing, to form circuit patterns on the outer conductive layers thereof. Such external patterns can include conductive pads on which conductors such as solder balls can be positioned to connect the structure to other components such as semiconductor chips, PCBs and chip carriers if so desired. The unique teachings of this invention are thus adaptable to a multitude of electronic packaging products.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A dielectric composition adapted for use in forming a dielectric layer for use in circuitized substrates, said dielectric composition comprising by weight:
a predetermined percentage of bismaleimide triazine resin;
a predetermined percentage of polyepoxide resin;
a predetermined percentage of thermoplastic resin;
a predetermined percentage of halogen-free flame retardant;
a predetermined percentage of methyl ethyl ketone;
a predetermined percentage of manganese octoate; and
a predetermined percentage of a coupling agent;
said dielectric composition not including a halogen or a fluoropolymer as part thereof.

2. The dielectric composition of claim 1 wherein said predetermined percentage of said bismaleimide triazine resin is within the range of from about 35% to about 42% by weight of said composition.

3. The dielectric composition of claim 1 wherein said predetermined percentage of said polyepoxide resin is within the range of from about 3% to about 10% by weight of said composition.

4. The dielectric composition of claim 3 wherein said polyepoxide resin includes dicyclopentadiene.

5. The dielectric composition of claim 1 wherein said predetermined percentage of said thermoplastic resin is within the range of from about 9% to about 15% by weight of said composition.

6. (canceled)

7. The dielectric composition of claim 1 wherein said predetermined percentage of said halogen-free flame retardant is within the range of from about 10% to about 33% by weight of said composition.

8. The dielectric composition of claim 7 wherein said halogen-free flame retardant contains phosphorus.

9. The dielectric composition of claim 1 wherein said predetermined percentage of said methyl ethyl ketone is within the range of from about 20% to about 40% by weight of said composition.

10. The dielectric composition of claim 1 wherein said predetermined percentage of said manganese octoate is within the range of from about 0.025% to about 0.075% by weight of said composition.

11. The dielectric composition of claim 1 wherein said predetermined percentage of said coupling agent is up to about 1% by weight of said composition.

12. The dielectric composition of claim 11 wherein said coupling agent comprises silane.

13. The dielectric composition of claim 1 further including a predetermined percentage of inorganic particulate filler.

14. The dielectric composition of claim 13 wherein said predetermined percentage of said inorganic particulate filler is within the range of from about 15% to about 40% by weight of said composition.

15. The dielectric composition of claim 13 wherein said inorganic particulate filler comprises spherical amorphous silica.

16. The dielectric composition of claim 13 wherein said predetermined percentage of said bismaleimide triazine resin is within the range of from about 29% to about 36% by weight of said composition.

17. The dielectric composition of claim 13 wherein said predetermined percentage of said polyepoxide resin is within the range of from about 3% to about 10% by weight of said composition.

18. The dielectric composition of claim 13 wherein said predetermined percentage of said thermoplastic resin is within the range of from about 6% to about 12% by weight of said composition.

19. The dielectric composition of claim 13 wherein said predetermined percentage of said halogen-free flame retardant is within the range of from about 10% to about 27% by weight of said composition.

20. The dielectric composition of claim 13 wherein said predetermined percentage of said methyl ethyl ketone is within the range of from about 20% to about 50% by weight of said composition.

21. The dielectric composition of claim 13 wherein said predetermined percentage of said coupling agent is no greater than about 1% by weight of said composition.

22. A dielectric layer adapted for forming part of a circuitized substrate, said dielectric layer comprising a predetermined percentage of bismaleimide triazine resin, a predetermined percentage of polyepoxide resin, a predetermined percentage of thermoplastic resin, a predetermined percentage of halogen-free flame retardant, a predetermined percentage of manganese octoate and a predetermined percentage of a coupling agent, said dielectric layer not including a halogen, a fluoropolymer, or methyl ethyl ketone as part thereof.
